(19) United States
(12) Patent Application Publication
(10) Pub. No.: US 2004/0042204 A1
(43) Pub. Date: Mar. 4, 2004

(54) Multifunctional lamp with the acoustic-optical siren

(76) Inventor: Se Kit Yuen, Kowloon (HK)

Correspondence Address: AKERMAN SENTERFITT, P.O. BOX 3188, WEST PALM BEACH, FL, 33402-3188, US

(21) Appl. No.: 10/648,895

(22) Filed: Aug. 27, 2003

(30) Foreign Application Priority Data
Aug. 29, 2002 (CN) 02338236.8
Nov. 18, 2002 (CN) 02285811.3

(51) Int. Cl. F21V 33/00; F21L 4/02

(52) U.S. Cl. 362/184; 362/190

(57) ABSTRACT

The present invention relates to an electric lamp, which has a long-life focus lamp, a long-life cold cathode lamp, a long-life siren lamp and a siren for asking for help. The characteristic of the said electric lamp is that the said light source could illuminate continuously over two days with the power supplied by the general battery, and also does not need to replace the lamp within 100,000 hours in use, which could provide to the user with a energy saving, easy to take and asking for help by the siren.

### FIELD OF THE INVENTION

The present invention relates to a kind of hand-hold lamp, and also relates to the lamp powered by the battery or commercial electric.

### OBJECT OF THE INVENTION

The purpose of the present invention is to provide a kind of improved design to this kind of lamp. Which could provide to the user with a energy saving, easy to take and asking for help by the siren.

### SUMMARY OF THE INVENTION

According to the present invention, it is provided with a kind of lamp, which includes a lamp body with at least three light sources, and siren and a rope ring held by hand. The said light source could illuminate continuously over two days with the power supplied by the general battery, and also does not need to replace the lamp within 100,000 hours in use, which could provide to the user with a energy saving, easy to take and asking for help by the siren.

### BRIEF DESCRIPTION OF THE DRAWINGS

The additional technical features of the present invention are explained in details as follows in combination with the drawings, in which:

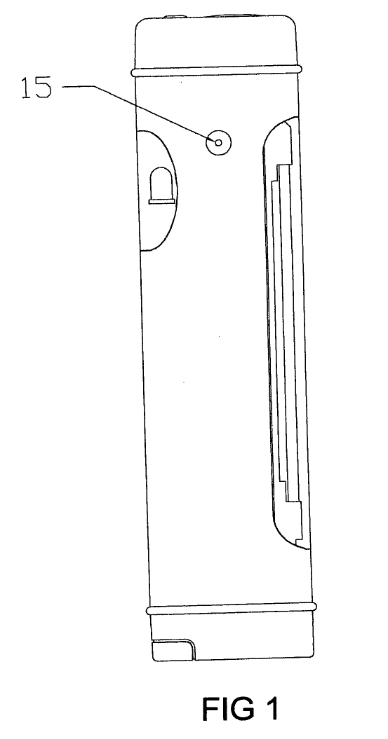

The FIG. 1 is the side view of the lamp according to the present invention;

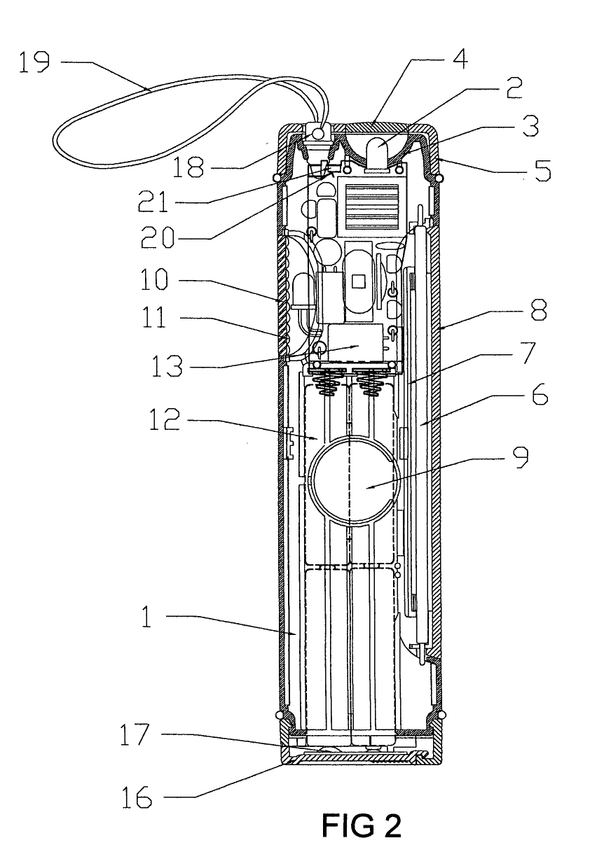

The FIG. 2 is the longitudinal sectional view of the lamp shown in FIG. 1;

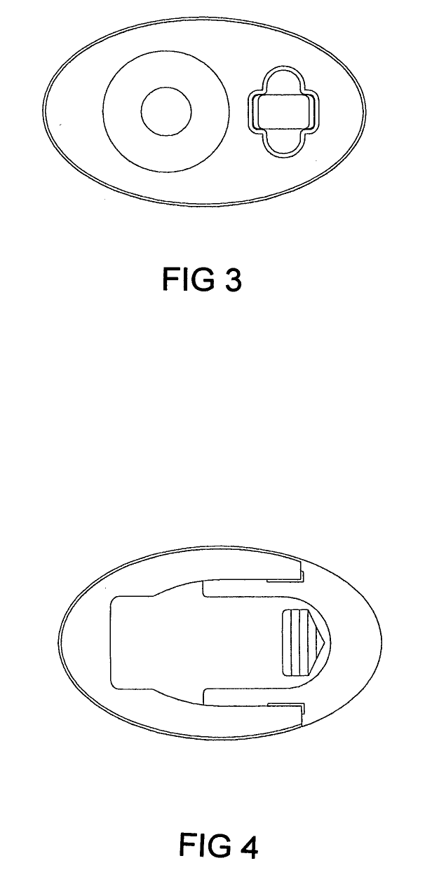

The FIG. 3 is the top view of the lamp shown in FIG. 1;

The FIG. 4 is the bottom view of the lamp shown in FIG. 1;

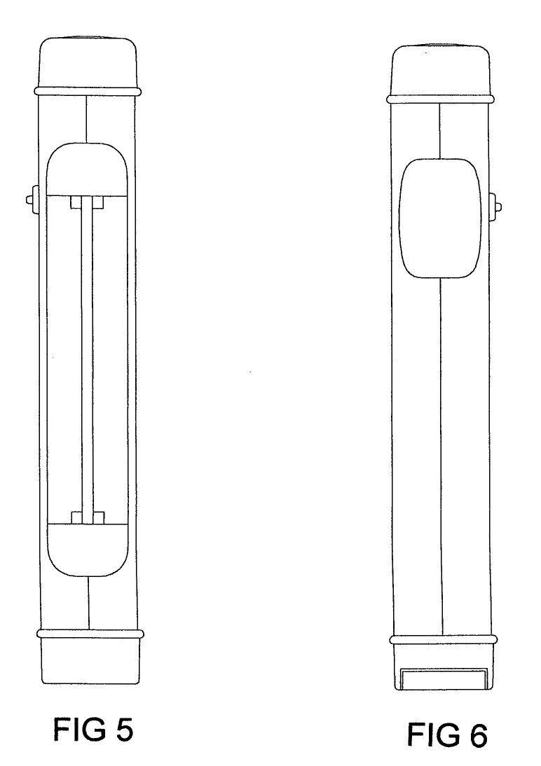

The FIG. 5 is the front view of the lamp shown in FIG. 1;

The FIG. 6 is the back view of the lamp shown in FIG. 1;

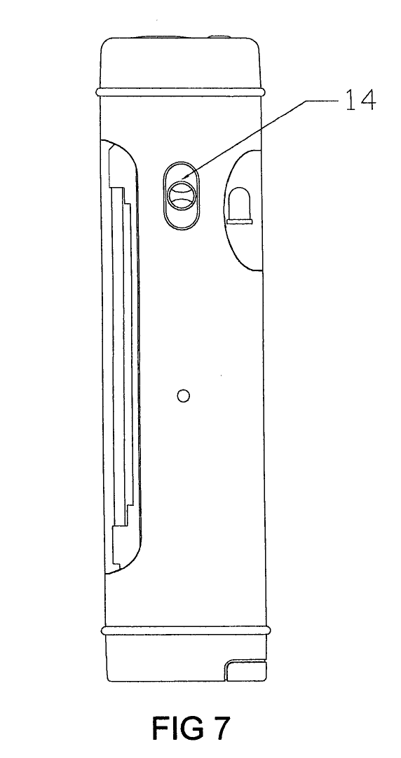

The FIG. 7 is another side view of the lamp shown in FIG. 1.

### DESCRIPTION OF THE PREFERRED EMBODIMENT

The lamp of the present invention generally includes the lamp body (1) in cuboid shape, a light source (2) being disposed at the upper end in the lamp body, a viewfinder surface (3) in paraboloid shape and a projecting plate (4) made of glass or other transparent material, the projecting plate (4) is generally in the paraboloid shape and has the function for convergencing the light source. The inner side surface of the said projecting plate (4) is sealed with the end surface within the front ring-shape lamp cap (5) which is mounted on the upper end of the lamp body (1). The one end of the lamp body (1) has cuboid light source (6) and a viewfinder (7) generally as a flat surface for reflecting and strengthening the light source, the light-permeating cover (8) is made of glass or other transparent material, the said light-permeating cover (8) is disposed at the front end of the lamp body (1). The flash light cover (10) is made of the glass , other transparent material or semi-transparent material, the flash light cover (10) has the ball body (11) for diffusing the refraction, which could make the refraction of the light source being scattered, and the flash light cover (10) is disposed at the back end of the light body (1).

As shown in the Figures, at least three light sources of the light body (1) are lamps which are powered by the electrical source (12) in the light body (1), the electrical source is connected with the electrical source circuit (13) in the lamp body (1) through the electrical line and connected to the outside socket (15), and the kenetic energy switch (14) is connected with the lamp. Obviously, the light source could be powered by battery or by rechargeable battery, the direct electrical source is connected with charger, and the electrical source circuit in the lamp body (1) is for charging.

As shown in the Figures, there is a battery gate at the lower end of the lamp body (1), the said battery gate (16) is the entrance and exit of the battery, the contacting metal plate (17) at the upper end of the battery gate (16) is for turning on the battery. The battery gate (16) is detachably fixed at the lower end of the lamp body (1).

There is a pull switch button (18) at the upper end of the lamp body (1), and a rope (19) held by hand is linked at the end of the said pull switch button (18). The said pull switch button (18) is detachably fixed at the upper end of the lamp body (1). The metal elastic plates (20) and (21) are separated while the pull switch button (18) being fixed at the upper end of the lamp body (1), but when the pull switch button (18) is separated from the lamp body (1), the metal elastic plates (20) and (21) are jointed together due to the elasticity of the metal itself, therefor the electric energy is generated to turn on the siren and which leads to the buzzer (9) to alarm, when the user of the lamp is in the dangerous situation, the pull switch button (18) of the rope held by hand is pulled, then the siren sends the information of asking for help.

In other words, the multi-functional cold cathode lamp of the present invention could be used as flashlight, and also easy to hold by hand or to load in the pocket, the multi-functional cold cathode lamp of the present invention could be used as the flashlight which focuses illumination in long distance and illuminates in different angles in short distance and sends signal light in different frequencies, which is very useful for protecting the lady's safety or for the people to travel.

What is claimed is:

1. A kind of hand-hold multi-functional cold cathode lamp, which comprising:
lamp body, which has inner chamber with focus lamp unit chamber disposed at its upper end, the cold cathode lamp unit chamber at the front end of the lamp body and the flash lamp unit chamber at the back end of the lamp body, the electric source circuit accommodated in the inner chamber of the lamp body and siren being pulled by the rope held by hand.

2. The hand-hold multi-functional cold cathode lamp according to the claim 1, wherein in the inner chamber there are at least three lamps, an arc reflecting unit, a plane reflecting unit, at least one switch, at least one socket with the outside power source, a pull switch hook pulled by the rope held by hand.

3. The hand-hold multi-functional cold cathode lamp according to the claim 1, wherein the said at least three light sources could be used continuously more than 100,000 hours.

4. The hand-hold multi-functional cold cathode lamp according to the claim 1, wherein the said lamp body is fixed by the ring made of rubber or other elastic material at the upper and lower ends, the said rubber ring is easy for user to hold and having the shock resistance function.

5. The hand-hold multi-functional cold cathode lamp according to the claim 1, wherein the fine and long-life cold cathode fluorescent lamp is adopted as the light source and which does not need to replace.

6. The hand-hold multi-functional cold cathode lamp according to the claim 5, wherein the said light source lamp is sealed by the transparent or semi-transparent material and emits the light which could not generate the heat, thus it is in high safety and even suited for little children.

7. The hand-hold multi-functional cold cathode lamp according to the claim 1, wherein it has a siren, which could send out the signal of asking for help when the user pull the button of the pull switch connected with the rope held by hand away from the lamp body.
